(19) United States
(12) Patent Application Publication
(10) Pub. No.: US 2012/0049038 A1
(43) Pub. Date: Mar. 1, 2012

(54) FORKLIFT WITH ANTI-VIBRATION MECHANISM

(76) Inventors: Paul J. Bachmeyer, Cary, NC (US); Claudio Oliosi, Monzambano (IT); Karl-Werner Kaufmann, Hilden (DE)

(21) Appl. No.: 13/262,728

(22) PCT Filed: Apr. 5, 2010
(86) PCT No.: PCT/US10/01024

§ 371 Date: Oct. 3, 2011

(30) Foreign Application Priority Data
Apr. 3, 2009 (IT) MI2009A000541

(51) Int. Cl. F16F 13/02; F16M 13/00

(52) U.S. Cl. 248/624; 248/309.1

(57) ABSTRACT

A mount for mounting a second structure on a first structure is provided. The mount (100) comprises a housing (10) having a first attachment surface for attachment to the first structure. The mount (100) also includes a biasing member (60) having a first end (62) located within the housing (10). A cupshaped retaining member (22) has a second attachment surface (29) for attaching the retaining member (22) to the second structure, wherein the retaining member (22) is adapted to receive a second end (64) of the biasing member (60) and at least partially locate within the housing (10) such that the biasing member (60) is constrained by the retaining member (22) and the housing (10). A cap (40) surrounds the retaining member (22) and provides a seal between the exterior of the retaining member (22) and the interior of the housing (10).

### CROSS REFERENCE

This application claims the benefit of, and incorporates by reference, Italian patent application number MI2009A000541 filed on Apr. 3, 2009.

### FIELD OF THE INVENTION

The present invention is directed to a mount for mounting a second structure on a first structure. The invention is particularly, although not exclusively, suited to use in wheeled and moving tracks work machines industrial vehicles, and agricultural vehicles where the mounts isolate the operator environment from vibrations elsewhere on the machine or vehicle.

### SUMMARY OF THE INVENTION

U.S. Pat. No. 5,988,610 and US2003/0047882 disclose liquid sealed mounts for mounting a second structure of an industrial vehicle (e.g. an operator cab) on a first structure of the vehicle (e.g. a load bed or chassis). The mounts are provided in order to avoid vibrations from the first structure being transferred into the second structure. Each mount comprises a cup-shaped casing attached to the first structure, the casing having an open end which is sealed by an elastic body. A retaining member and elongate stud are arranged in the housing so that the stud extends through an aperture in the elastic body for attachment to the second structure. A biasing spring is located in the casing and provides a biasing force to the retaining member. The retaining member and stud may therefore slide axially relative to the elastic body and housing under the action of either the biasing spring or the relative movement between the two structures. A viscous liquid held in the housing creates a damping effect as the retaining member moves in the casing.

As it is the stud which extends through the elastic body, the retaining member is confined between the housing and the elastic body. As a result, the biasing spring in the casing must be of a sufficiently short length to fit between the retaining member and the end of the casing. This size requirement for the spring compromises the amount of static deflection possible. This in turn necessitates the use of a spring having a higher vertical stiffness and resultant natural frequency. This impedes the ability of the mount to absorb vibrations satisfactorily.

It is an aim of the present invention to obviate or mitigate this and other disadvantages inherent in the prior art.

According to a first aspect of the present invention, there is provided a mount for mounting a second structure on a first structure, the mount comprising a housing having a first attachment surface for attachment to the first structure, a biasing member having a first end located within the housing, a cup-shaped retaining member having a second attachment surface for attaching the retaining member to the second structure, the retaining member being adapted to receive a second end of the biasing member and at least partially locate within the housing such that the biasing member is constrained by the retaining member and the housing, and a cap surrounding the retaining member and providing a seal between the exterior of the retaining member and the interior of the housing, wherein the cap includes a substantially rigid inner sleeve member adapted to prevent radial movement of the retaining member relative to the cap and housing.

The retaining member may have a closed end having an interior surface and an exterior surface, wherein the interior surface constrains the second end of the biasing member and the exterior surface is the second attachment surface.

The cap may include a first control surface adapted to limit the relative axial movement of the retaining member in a first direction, and the retaining member may include a first radially projecting damping plate projecting towards the housing and adapted to selectively contact the first control surface of the cap. The first damping plate may be integrally formed with the retaining member.

The biasing member may be a compression spring.

The first attachment surface may be a first flange projecting radially from the housing, the first flange having a plurality of first attachment apertures adapted to receive mechanical fixtures.

The cap may be formed from a resilient material. The resilient material may be rubber.

The inner sleeve may be formed from a plastics material and bonded to the cap.

The cap may include an annular reinforcing ring. The reinforcing ring may include a second radially projecting flange and a plurality of second attachment apertures therein. The second radially projecting flange may have substantially the same shape as the first flange of the housing and the plurality of second attachment apertures may, in use, align with the first apertures of the first flange.

The mount may further comprise one or more securing members adapted to secure the first and second flanges together when not in use.

The mount may further comprise a threaded attachment member axially projecting from the second attachment surface.

The first control surface may be adapted to limit the relative axial movement of the retaining member in a first direction away from the housing, and the cap may include a second control surface adapted to limit the relative axial movement of the retaining member in a second direction towards the housing. The mount may further comprise a second damping plate located on the threaded attachment member and adapted to selectively contact the second control surface of the cap.

The mount may further comprise one or more friction members adapted to generate friction between the retaining member and housing. The one or more friction members may be located on the circumference of the first damping plate. Alternatively, the friction members may be located on the inner sleeve of the cap, or an internal surface of the cup-shaped retaining member. Alternatively, the friction members may be located between the retaining member and the biasing member. In the case where the biasing member is a spring the one or more friction members may be located on an inner surface of the retaining member and are contactable with the coils of the spring to generate friction therebetween.

The mount may contain a liquid, and the cap may include a membrane liquid barrier adapted to seal the liquid within the housing. The cap may include one or more orifices allowing the liquid to flow through the cap between a first liquid chamber formed between the cap and the membrane, and a second liquid chamber formed between the cap and the housing.

The liquid may be a magnetorheological liquid, and the mount may further comprise an electromagnet located proximate a liquid filled gap in the housing and adapted to selectively apply a magnetic field to the liquid.

According to a second aspect of the invention, there is provided a system for mounting a second structure on a first structure, the system comprising at least two mounts according to the first aspect of the invention.

Each mount may contain a magnetorheological liquid and have a electromagnet adapted to selectively apply a magnetic field to the liquid, the system further comprising a controller adapted to control the electromagnets.

According to a third aspect of the invention, there is provided a work machine comprising a second structure mounted on a first structure by at least two mounts according to the first aspect of the invention.

In this specification, the term “work machine” is intended to include any wheeled or tracked machine used in an industrial application or environment, whether on- or off-highway. Non-limiting examples of such applications are materials handling and distribution, construction and agriculture.

The first structure may be a load-carrying structure on the work machine, whilst the second structure may be an operator environment on the work machine. An “operator environment” may be an operator cab, a platform upon which the operator is located, or a seat upon which the operator sits during operation of the work machine.

The work machine may be a forklift truck, where the first structure includes a load-carrying platform and the second structure includes an operator cab.

According to a fourth aspect of the present invention, there is provided a mount for mounting a second structure on a first structure, the mount comprising, a housing having a first attachment surface for attachment to the first structure, a biasing member having a first end located within the housing, a cup-shaped retaining member having a second attachment surface for attaching the retaining member to the second structure, the retaining member being adapted to receive a second end of the biasing member and at least partially locate within the housing such that the biasing member is constrained by the retaining member and the housing, and a cap surrounding the retaining member and providing a seal between the exterior of the retaining member and the interior of the housing, wherein the cap includes a friction interface adapted to control movement of the retaining member relative to the cap and housing.

According to a fifth aspect of the present invention, there is provided a mount for mounting a second structure on a first structure, the mount comprising, a housing, having a first attachment surface for attachment to the first structure, a biasing member having a first end located within the housing, a magnetorheological liquid in the housing and in contact with the biasing member, a liquid barrier, wherein the magnetorheological liquid is contained in the housing and the biasing member supports a load between the first and second structures.

### BRIEF DESCRIPTION OF THE DRAWINGS

Preferred embodiments of the present invention will now be described, by way of example only, with reference to the accompanying drawings.

FIGS. 1(a)-1(c) are perspective, plan and vertical section views, respectively, of a housing for a mount;

FIGS. 2(a) and 2(b) are plan and vertical section views, respectively, of a retaining member for a mount;

FIGS. 3(a)-3(c) are perspective, plan and vertical section views, respectively, of a seal for a mount;

FIGS. 4(a)-4(c) are perspective, plan and vertical section views, respectively, of a first embodiment of a mount incorporating the components shown in FIGS. 1 to 3;

FIG. 5 is a schematic view of the mount shown in FIG. 4 when in use on a work machine;

FIG. 6 is a vertical section view showing a second embodiment of a mount;

FIG. 7 is a vertical section view showing a third embodiment of a mount;

FIG. 8 is a vertical section view showing a fourth embodiment of a mount;

FIG. 9a is a vertical section view showing a fifth embodiment of a mount;

FIGS. 9b to 9d are top views of damping discs for use with the mount of FIG. 9a;

FIG. 10 is a vertical section view showing a sixth embodiment of a mount;

FIG. 11 is a vertical section view showing a seventh embodiment of a mount; and

FIG. 12 is a vertical section view showing an eighth embodiment of a mount.

### DETAILED DESCRIPTION OF THE PREFERRED EMBODIMENT

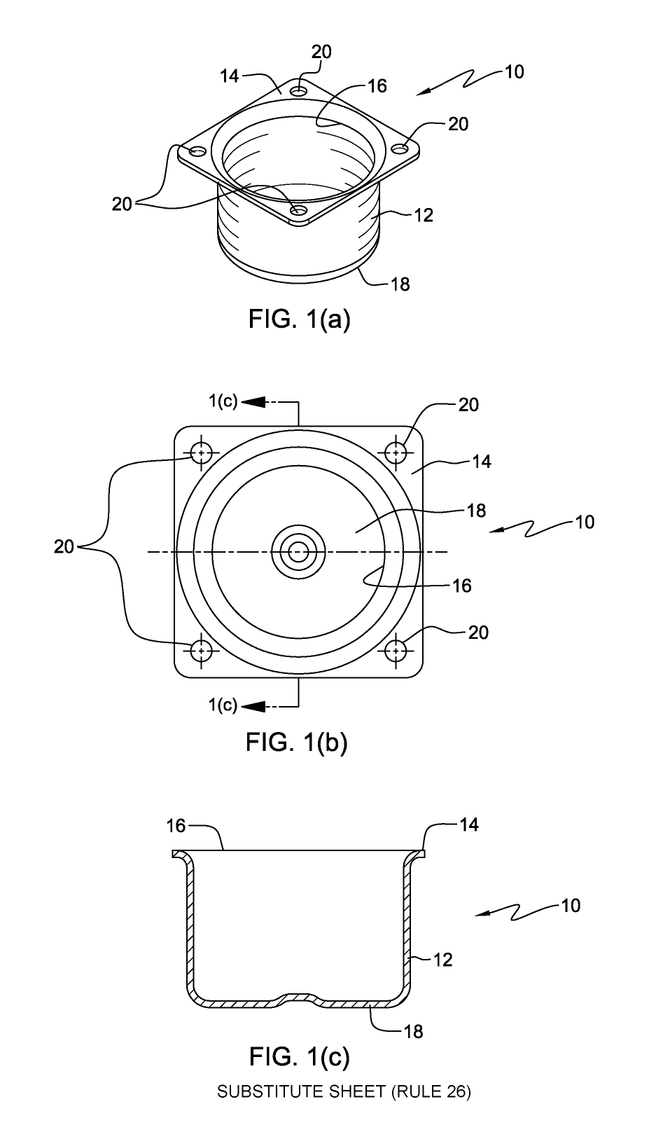

Referring to FIGS. 1(a)-1(c), there is shown a housing 10 for a mount in accordance with the present invention. The housing 10 is preferably cup-shaped and is made up of a cup portion 12 and a flange portion 14 which projects radially outwards from the cup portion 12. The cup portion 12 and flange portion 14 are preferably formed from a single piece of metal. However, it should be appreciated that the cup portion 12 and the flange portion 14 may be alternatively made of a plastic material. The housing 10 has an open end 16 adjacent the flange portion 14 and a closed end 18 remote from the flange portion 14. When viewed in plan, as in FIG. 1(b), the flange portion 14 is preferably substantially square-shaped. As a result, the flange portion 14 forms four lugs about the circumference of the housing 10. Each lug of the flange portion 14 is provided with a threaded aperture 20. The upper surface of the flange portion 14 as seen in FIG. 1(b) acts as a first attachment surface for the mount.

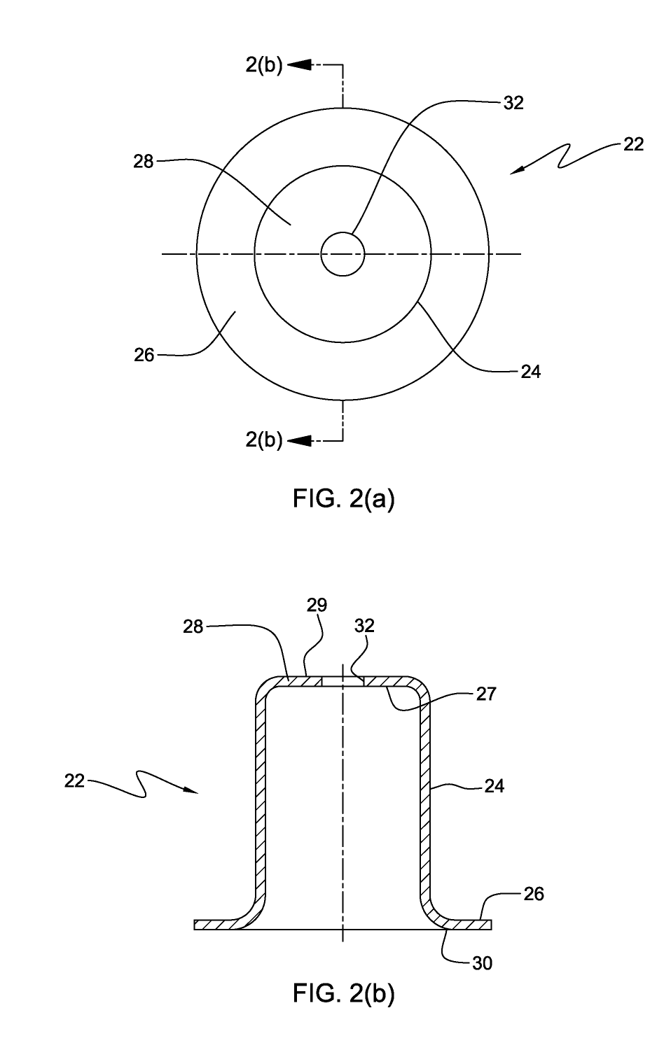

FIGS. 2(a) and 2(b) show a cup-shaped retaining member 22 for a mount in accordance with the present invention. The retaining member 22 has a cup portion 24 and a damping plate 26 which projects radially outwards from the cup portion 24. The retaining member 22 has a closed end 28 remote from the damping plate 26 and an open end 30 adjacent the damping plate 26. The closed end 28 has an inner surface 27 and an outer surface 29, and includes a central aperture 32. When assembled to form the mount, the outer surface 29 acts as a second attachment surface for the mount. The cup portion 24 and damping plate 26 are preferably formed from a single piece of metal.

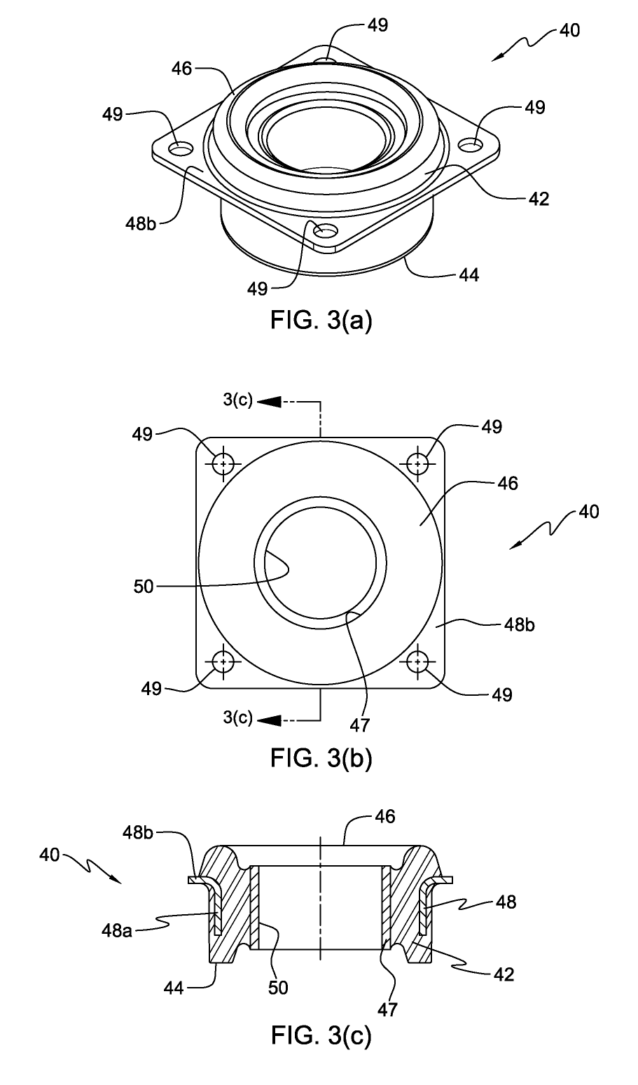

FIGS. 3(a)-3(c) show views of a seal, or cap, 40 for a mount in accordance with the present invention. The seal 40 is preferably formed from a resilient elastomer material and has an annular body 42 which has a first, or lower, control surface 44 and a second, or upper, control surface 46. The first and second control surfaces 44, 46 face in opposing directions. The annular seal body 42 has an internal surface 47 which defines a central aperture through the seal 40. The seal body 42 is preferably formed by moulding rubber about a metal reinforcing ring 48 in a conventional manner. Bonded to the internal surface 47 of the body 42, preferably during the same moulding process, is a substantially rigid sleeve 50. The sleeve 50 is preferably formed from a suitable plastics material. However, it should be appreciated that the sleeve 50 could be formed any other suitable material, e.g. metal, such as bronze, or a composite sintered material.

As best seen in FIGS. 3(a) and 3(b), the reinforcing ring 48 comprises a ring body 48a and a flange 48b which projects radially from the ring body 48a.

When viewed in plan, as in FIG. 3(b), the flange 48b is preferably substantially square-shaped. As a result, the flange 48b forms four lugs about the circumference of the seal 40. Each lug of the flange portion 48b is provided with a threaded aperture 49. The size and shape of the flange 48b and the location of the apertures 49 substantially matches that of the flange portion 14 of the housing 10 and the apertures 20 provided thereon. Thus, there is no overlap between the flange portion 14 of the housing 10 and the ring flange 48b of the seal 40 when they are placed together during assembly, and the respective apertures 20,49 are aligned with one another.

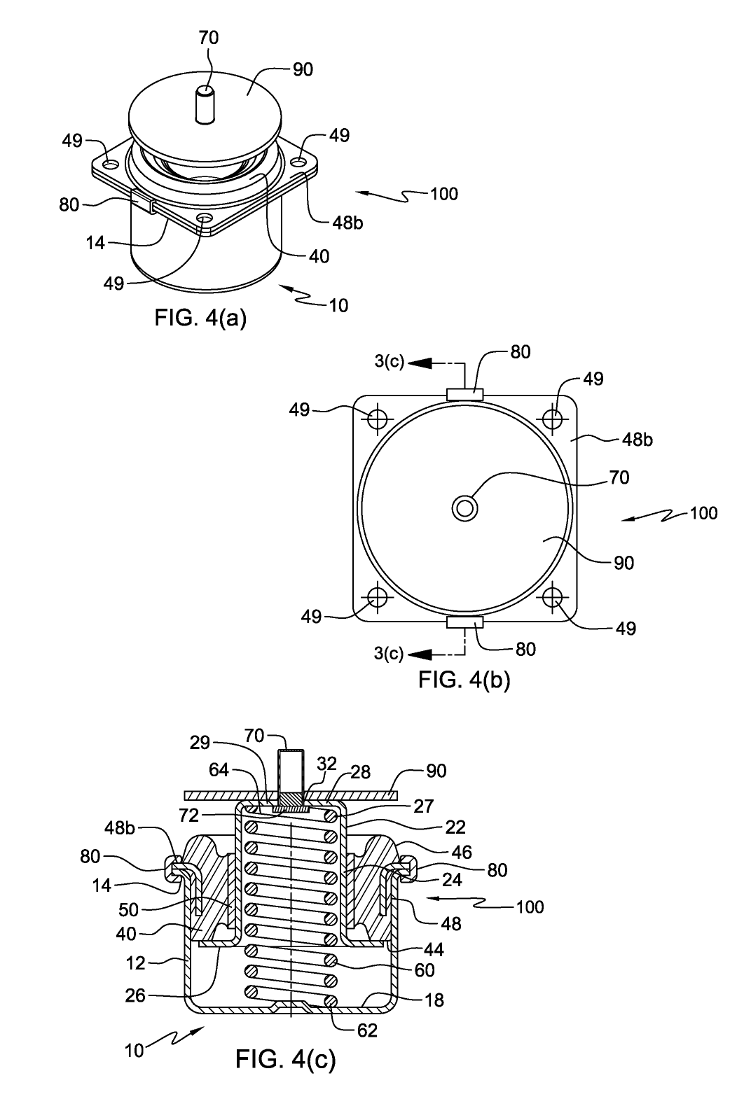

FIGS. 4(a)-4(c) show views of an assembled mount according to the present invention. The manner in which the mount, generally designated 100, is assembled using the components shown in FIGS. 1-3 will now be described with particular reference to the section view of FIG. 4(c).

Firstly, a biasing member 60 having first and second ends 62,64 is placed in the cup portion 12 of the housing 10 so that the first end 62 of the biasing member 60 lies against the closed end 18 of the housing 10. The biasing member 60 is preferably a compression spring and is preferably manufactured from steel. Next, the cup-shaped retaining member 22 is inverted and placed over the exposed second end 64 of the biasing member 60 so that the retaining member 22 is at least partially located within the cup portion 12 of the housing 10. Prior to being placed over the end of the biasing member 60, a mechanical fixture 70 such as a threaded bolt, for example, is inserted into the aperture 32 in the closed end 28 of the retaining member 22. The fixture 70 is inserted into the aperture 32 from inside the retaining member 22, with a head portion 72 of the fixture 70 preventing the fixture 70 from passing entirely through the aperture 32. The fixture 70 is therefore held by the retaining member 22 but projects from the outer surface 29 of the closed end 28.

With the retaining member 22 placed over the biasing member 60, the second end 64 of the biasing member 60 lies against the inner surface 27 of the closed end 28 of the retaining member 22. The biasing member 64 is therefore constrained by the housing 10 and the retaining member 22.

In the next stage of the assembly, the seal 40 is placed over the retaining member 22 and into the housing 10 such that the seal 40 locates in a circumferential gap between the retaining member 22 and the housing 10. At least part of the cup portion 24 of the retaining member 22 is located in the central sleeve 50 of the seal 40. As the seal 40 is pushed down over the retaining member 22 the first control surface 44 will come into contact with the damping plate 26 of the retaining member 22. The seal 40 will therefore press down on the retaining member 22, which in turn at least partially compresses the biasing member 60 within. As the seal 40 is pressed further down into the housing 10 the flange 48b of the seal reinforcing ring 48 will come into contact with the flange portion 14 of the housing 10. As described above, the flange 48b of the ring 48 and the flange portion 14 of the housing are formed so as to have a substantially identical shape and to have their respective apertures 20, 49 in alignment. As the combination of the seal 40 and retaining member 22 are partially compressing the biasing member 60, a plurality of temporary securing clips 80 are then secured over sections of the flange 48b and flange portion 14 to hold them together against the force of the biasing member 60. These clips 80 are for transportation and storage only, and will be removed once the mount has been securely attached to both the first and second structures. Following the aforementioned assembly steps, a pre-compression force is now being applied to the biasing member 60.

Either prior to the introduction of the retaining member 22 into the housing or else after the aforementioned steps, a second damping plate 90 may be placed over the mechanical fixture 70 onto the second attachment surface provided by the outer surface 29 of the retaining member 22. As can be seen in FIG. 4(c) the second damping plate 90 has a larger diameter than the cup portion 24 of the retaining member 22. The damping plate 90 may also be part of a work machine (see below).

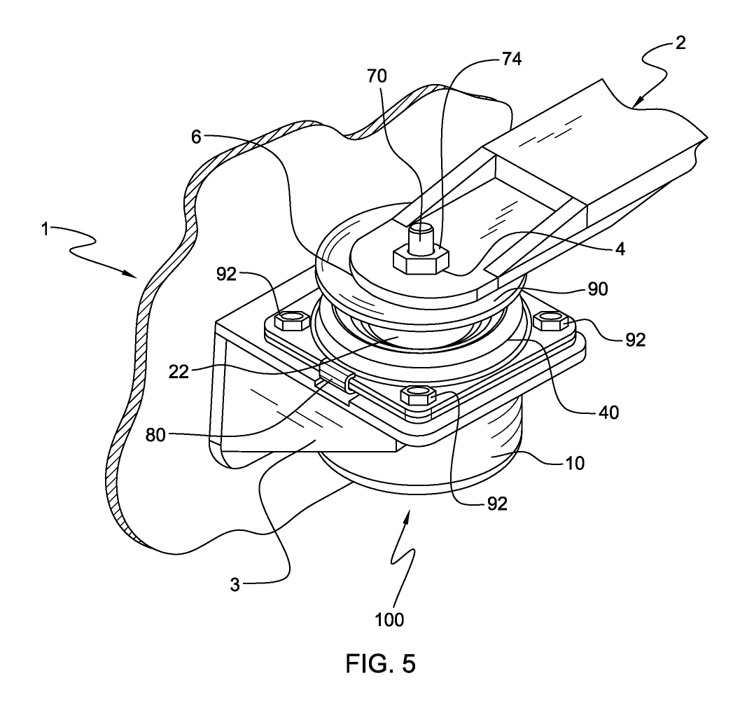

Once assembled, the mount 100 is secured to the first and second structures 1, 2 of a work machine or the like, as illustrated in FIG. 5. The mount 100 is secured to the first structure 1, typically a load-carrying frame or body, by mechanical fixtures 92 which are threaded through the apertures 20, 49 in the housing 10 and seal 40 into corresponding apertures of a bracket 3 provided on the first structure 1. Conventional nut and bolt fixtures may be used as the mechanical fixtures. Thereafter, the fixture 70 projecting from the retaining member 22 is passed through an attachment aperture 4 on the second structure 2, typically a support forming part of the operator compartment of the machine. As a result, the second damping plate 90 will lie against a surface 6 of the second structure 2. As described above, the second damping plate 90 may be formed as part of the work machine and does not necessarily be formed as a separate plate. Again, a conventional securing nut 74 can be threaded over the end of the fixture 70 in order to secure the mount 100 to the second structure 2. Once successfully secured to the first and second structures 1,2, the securing clips 80 can be removed.

Referring back to FIG. 4(c), when the mount 100 is in use, relative movements or vibrations of the first structure will cause the retaining member 22 to slide axially towards, or away from, the housing 10. This in turn will either compress or expand the biasing member 60, thereby absorbing the movement. Should the first structure be subject to a large movement or amplified vibration relative to the second structure, the biasing member 60 may compress a sufficient amount to bring the second damping plate 90 into contact with the second, or upper, control surface 46 of the seal 40. This increases the stiffness of the system. In this situation, the second control surface 46 limits the amount of relative axial movement available to the retaining member 22 as it moves further into the housing 10. Otherwise, the first damping plate 26 could come into contact with the closed end 18 of the housing 10.

During a relative movement or vibration of the first structure away from the second structure, or else during a rebound motion following a compressive movement as described above, the selected vertical stiffness of the biasing member 60 ensures that there is a controlled outward movement of the retaining member 22 from the housing 10 as the biasing member 60 expands. Should the biasing member 60 expand sufficiently to bring the first damping plate 26 into contact with the seal 40, the provision of the first, or lower, control surface 44 on the seal 40 limits the outward movement available to the retaining member 22 caused by the expanding biasing member 60.

During any of these relative motions, the guiding of the retaining member 22 by the rigid sleeve 50 of the seal 40 ensures that the vertical motions and forces are decoupled from any radial motions or forces in either the fore/aft or lateral directions.

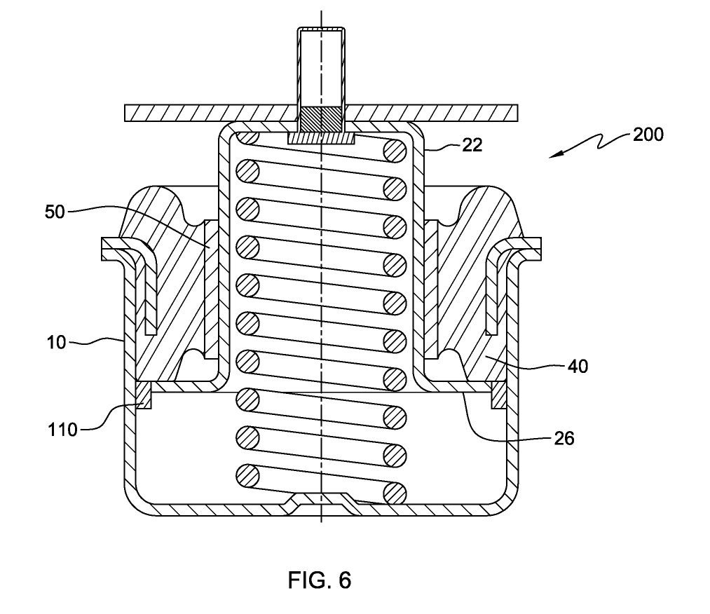

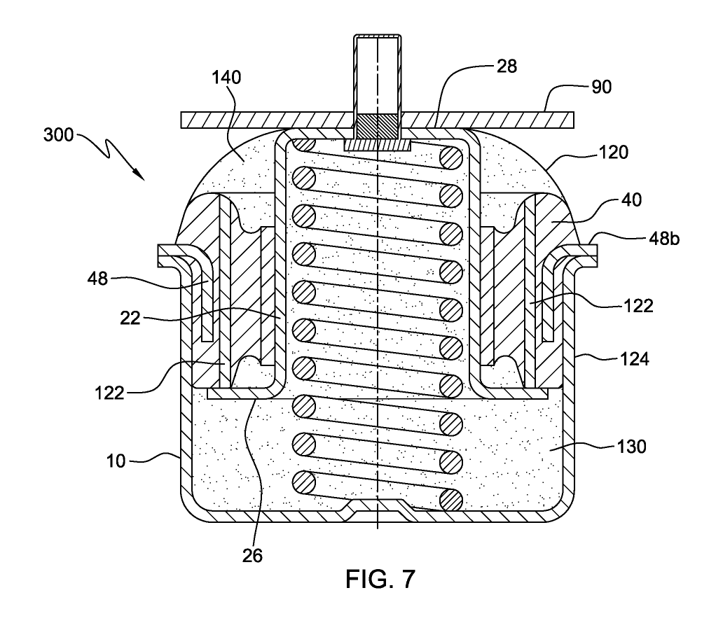

FIGS. 6 and 7 provide vertical section views of alternative embodiments of the mount, generally designated 200 and 300. The sections are taken at the same point as that for FIG. 4(c) and illustrate several optional features which could be added to the mount to add damping effects. The optional features shown in the second and third embodiments provide damping to the mount either in the form of surface effect damping and/or viscous damping. It should be noted that whilst the optional features are illustrated in separate embodiments, they may also be combined together in a single mount in order to provide combined surface effect and viscous damping. Furthermore, unless otherwise indicated the features described are identical to those of the first embodiment and the same reference numerals have therefore been used.

The second embodiment of the mount 200 shown in FIG. 6 has been adapted to add surface effect damping. In this embodiment, one or more friction discs or pads 110 are provided in order to increase the resistance to the movement of the retaining member 22 relative to the housing 10 and seal 40. The friction disc 110 is preferably attached to the circumference of the first damping plate 26 so that it contacts the internal surface of the housing 10. In a preferred embodiment the friction disc 110 is comprised of a bonded elastomeric friction body bonded to the damping plate 26. The mount would operate in substantially the same manner as that of the first embodiment. However, as the retaining member 22 moves axially within the housing 10 the friction generated by the contact of the friction disc 110 on the internal surface of the housing provides a damping effect. In addition to, or else instead of, being attached to the damping plate the friction discs or pads could also be located between the sleeve 50 and the outer surface of the retaining member 22. In this case, the discs or pads could be attached to either the sleeve 50 or retaining member 22. Alternatively, the sleeve 50 itself could be formed such that it generates a frictional force on the sliding retaining member, either through use of a particular material for the sleeve or else by treating the inner surface of the sleeve. The degree of damping can be adjusted by varying the size and/or number of friction discs or pads used.

The third embodiment of the mount 300 shown in FIG. 7 has been adapted to include viscous damping, either alone or in combination with magnetorheological (MR) damping effects. During assembly of the mount 300, a viscous damping liquid is dispensed into the housing 10 prior to the seal 40″ being positioned over the retaining member 22 in the open end of the housing 10. In preferred embodiments the mount 300 contains a high viscosity liquid, preferably a greater than 10,000 centistokes high viscosity liquid (prefer >20,000; >30,000; >40,000; >50,000; prefer in the 50,000 to 150,000 cSt, prefer in the 50,000 to 70,000 centistokes range). In preferred embodiments the high viscosity liquid is comprised of a silicone liquid. In preferred embodiments the liquid mount contains magnetorheological (MR) liquid comprised of magnetic-responsive iron particles dispersed in the viscous liquid. In preferred embodiments the liquid mount magnetorheological (MR) liquid is comprised of iron particles, glycol, and a thickener, preferably magnetic-responsive iron particles, a thickener, an ionic thixotropic additive, and glycol liquid, preferably a glycol-water mixture comprising at least 50 percent by weight of a glycol compound. The thickener is preferably a fumed silica and the ionic thixotropic additive is at least one ionic thixotropic additive preferably chosen from the ionic thixotropic additive group comprised of sodium nitrite, sodium chloride, sodium acetate, and sodium benzoate.

Once the seal 40″ is installed a membrane liquid barrier 120 is placed over the closed end 28 of the retaining member 22 and is attached around the circumference of the flange 48b of the seal ring 48 to provide a liquid seal to prevent the liquid escaping from the mount 300. The mount 300 then has a lower, or first, liquid chamber 130 and an upper, or second, liquid chamber 140 separated by the seal 40″. The membrane 120 preferably has negligible vertical stiffness and so does not interfere with the natural frequency or overall vertical stiffness of the mount 300.

To allow viscous damping, the seal 40″ is adapted in the third embodiment to include a number of flow passages 122 which permit flow of the viscous liquid between the first and second chambers 130,140. In this way, the liquid can provide a damping effect when the retaining member 22 is moving in either axial direction, with the first damping plate 26 immersed in the liquid in the first chamber 130 and the second damping plate 90 pressing down on the liquid in the second chamber 140 during a compressive motion of the biasing member 22. As the retaining member 22 and damping plates 26, 90 move, the liquid will be forced from one chamber to the other. The first damping plate 26 is sized so that a radial gap 124 is left between the circumference of the plate 26 and the internal wall of the housing 10. This allows the plate 26 to generate a shearing effect as it moves in the liquid, which further improves the damping effect. The damping provided by the liquid in this embodiment can be adjusted by varying the viscosity of the liquid used, as well as by adjusting the size of the first damping plate 26 and hence the size of the gap 124.

To supplement the viscous damping the liquid employed may be a magnetorheological (MR) liquid, containing magnetically responsive particles suspended in the liquid. Each mount 300 would include an electromagnet (not shown) located in and/or proximate the first chamber 130, the second chamber and/or the flow passages 122 and connected to a controller to provide a current source to generate a magnetic field, preferably an external controller (not shown). With the electromagnet switched off no magnetic field is applied and the liquid would act as described above. However, when the electromagnet is switched on and a magnetic field is applied to the liquid in the mount 300, the particles align to the field and the apparent viscosity of the liquid increases. The controller can be supplied with a variety of parameters and signals which allow it to control when the electromagnet should be activated and the yield strength of the liquid increased. The controller can also be used as part of a system to control a number of the mounts being employed for mounting one structure on another structure.

In preferred embodiments of the invention, the magnetorheological liquid is provided comprising a glycol based liquid with fumed silica, an ionic thixotropic additive, and at least some water. Preferably the magnetorheological liquid is provided comprising magnetic-responsive particles, a thickener, an ionic thixotropic additive, and a carrier liquid wherein the carrier liquid comprises a glycol-water mixture comprising at least 50 percent by weight of a glycol compound. In one embodiment of the present invention, the carrier liquid comprises a mixture of ethylene and propylene glycol. In another preferred embodiment of the present invention, the water is present in the carrier liquid in an amount up to 50 percent by weight based on the weight of the carrier liquid. In still further preferred embodiments of the present invention, water is present in an amount from about 0.01 to about 10 weight percent, from about 0.1 to about 5 weight percent, and at least 2.0 percent by weight based on the weight of the carrier liquid. In embodiments the thickener comprises fumed silica, preferably comprising a BET surface area of 200 m²/g or less. In alternate preferred embodiments of the present invention, the thickener is present in the magnetorheological liquid at 0.01 to 5.0 percent by weight, at 0.5 to 3.0 percent by weight and at about 1.5 percent by weight based on the total weight of the magnetorheological liquid. In another embodiment of the present invention, the ionic thixotropic compound comprises the structure AB_{y}, wherein A is a cation with a charge (valence) of +y and B is a monovalent anion. In preferred embodiments of the present invention, the cation comprises at least one of an alkali metal and alkaline earth metal, and the anion comprises at least one of halides, inorganic oxoanions, carboxylates, and alkoxides. In one embodiment of the present invention, the anion comprises the following formula:

R—CO₂⁻

wherein R comprises an alkyl or aryl group. In one preferred embodiment of the present invention, R comprises CH₃ or C₆H₆. In preferred embodiments of the present invention, the ionic thixotropic additive comprises at least one of sodium nitrite and sodium chloride, and/or the ionic thixotropic additive comprises an organic carboxylate salt, sodium acetate and/or sodium benzoate. In preferred embodiments of the present invention, the ionic thixotropic additive provides an ionic strength of at least about 0.0007 moles ions per gram of carrier liquid, is present in an amount of at least 0.7 weight percent based on the total weight of the magnetorheological composition, is present in an amount of at least 0.01 moles ions per gram fumed metal oxide, is present in an amount effective to provide an excess ionic content relative to the thickener, and/or is present from 0.05 to 5.0 weight percent based on the total weight of the magnetorheological liquid. In a still further embodiment of the present invention, the magnetically responsive particles are present in an amount from about 15 to about 45 volume percent based on the total volume of the magnetorheological liquid.

The mount of the present invention is particularly suited for use in materials handling work machines. One preferred example of such a machine is a forklift truck. Mounts according to the present invention may be employed to support the operator compartment of the truck relative to the truck frame, which receives shocks and vibrations from the load-handling platform of the truck. The truck would employ a system of at least two mounts to provide support and stability in response to vertical loadings on the frame or operator compartment. The system may also include an additional pair of mounts to provide support and stability in response to loadings in either the lateral or fore/aft directions. In a system having upper and lower pairs of mounts the upper mounts would be mounts in accordance with the present invention. The pair of bottom mounts may be a conventional sandwich-type mount made from bonded rubber.

The mount of the present invention provides a number of advantages. By employing a biasing member which is pre-compressed between the housing and retaining member the present invention can provide a mount having a relatively low natural frequency (preferably in the range 3.2-3.6 Hz) but with a reduced static deflection. As a result, the travel required is reduced and the mount is more compact while still preventing the transmission of excessive movement and vibration from the first structure to the second structure. By way of comparison, tests conducted by the applicant showed that to obtain the same reduction in static deflection using a pure linear spring which was not pre-compressed, the spring would need to be considerably stiffer and have a vertical natural frequency of 7.3 Hz. This increased vertical stiffness and natural frequency would transmit more movement and vibration between the first structure and the second structure. The mount of the present invention can be tuned to accommodate different loads simply by swapping the existing biasing member for another of either increased or reduced vertical stiffness.

A further advantage of the present invention is the provision of the rigid sleeve between the resilient seal and the retaining member. By employing a rigid sleeve the mount can decouple vertical stiffness from radial stiffness in the lateral and fore/aft directions. Thus, vertical loadings on the mount do not result in any deflection of the seal in either the lateral or fore/aft directions. This allows stiffness requirements in the vertical and radial directions to be met independently, thereby avoiding having to compromise one in order to meet the other.

Another benefit of the present invention is the use of the upper and lower surfaces of the seal to limit the motion of the retaining member within the housing. Employing a seal with integral upper and lower control surfaces simplifies the production of the mount with a consequent reduction in production costs. The seal is manufactured from an elastomer having the desired stiffness characteristics in both the vertical and radial directions. This stiffness can be tuned by replacing the seal with another seal of reduced or increased stiffness as required. As the biasing member and seal can both be replaced easily, the present invention provides a mount whose spring rates can be very simply tuned in each of the vertical, lateral and fore/aft directions depending on the application.

As highlighted above, the present invention can also easily incorporate optional features to introduce damping effects to the mount, whether the modification of damping levels is to be by way of surface effect, viscous or MR damping. This too can benefit production costs as any of the these forms of damping can be incorporated simply by adding one or more additional features to the basic mount, thereby avoiding the need for separate production lines or re-engineering to incorporate the different forms of damping. As explained above, the levels of damping offered by these modifications can also be tuned, such as by varying numbers of friction discs, using a liquid with a different viscosity, varying the current/voltage to the electromagnet, for example.

Where viscous damping is provided in the mount, the sealing membrane liquid barrier preferably has negligible vertical stiffness. Therefore it preferably does not supplement the vertical stiffness of the biasing member and interfere with the desired natural frequency and overall absorption performance of the mount.

The provision of the second damping plate not only provides a limit to the axial movement of the retaining member into the housing, but also provides a rigid surface for attaching the mount to the second structure. The absolute limitation on axial movement of the retaining member in either direction can be tuned by varying the depth and/or stiffness of the seal, whose control surfaces the retaining member will come into contact with.

Whilst it is preferred that the closed end of the retaining member performs the twin function of constraining the biasing member and providing the surface to which the second structure is attached, the invention is not limited to this particular arrangement. Instead, for example, the interior of the retaining member may include one or more steps or lugs against which the second end of the biasing member lies. In addition, the second attachment surface could be provided by an additional plate member or the like, which is fixed to the outer surface of the closed end of the retaining member.

Whilst adding further advantages to the present invention in terms of motion control, the damping plates and the control surfaces on the cap are not essential to the function of the invention. Therefore, the retaining member need not be provided with a first damping plate adjacent its open end or a second damping plate adjacent its closed end. Similarly, the cap can be provided without the upper and lower control surfaces.

The threaded attachment member which allows the mount to be attached to the second structure can be supplied independently of the remainder of the mount. Therefore the present invention should not be limited to only a mount which comprises such an attachment member.

The inner sleeve of the cap is preferably formed from a suitable plastics material. However, it may also be manufactured from a metal such as steel or copper, for example.

The biasing member is preferably a coiled compression spring made from steel. However, the biasing member may alternatively be provided by alternative means. For example, it may be formed from a solid piece of elastomeric material instead.

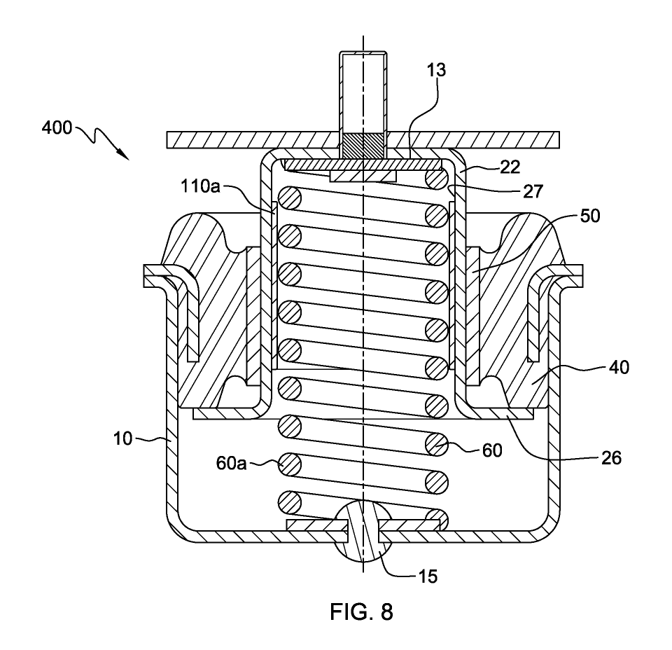

Although the surface effect damping of the second embodiment of the mount 200 has been illustrated and described above as including one or more friction discs or pads 110 between the first damping plate 26 and the housing 10, and/or between the sleeve 50 and the outer surface of the retaining member 22, it should be appreciated that additional, or alternative, surface effect damping could be achieved by including one or more friction discs or pads, or elastomer portions between the inner surface 27 of the retaining member 22 and the biasing member 60. That is, the friction discs or pads, or elastomer portions (an example of a friction interface) may be located between the inner surface 27 of the retaining member 22 and the coils of the biasing member 60, as illustrated in FIG. 8.

FIG. 8 provides a vertical section view of an alternative embodiment of the mount, generally designated 400. The section is taken at the same point as that for FIG. 4(c) and illustrates optional features which could be added to the mount to add damping effects. The optional feature of FIG. 8 provides damping to the mount in the form of surface effect damping. Unless otherwise indicated the features described are identical to those of the first embodiment and the same reference numerals have therefore been used.

The fourth embodiment of the mount 400 shown in FIG. 8 adds surface effect damping between the inner surface 27 of the retaining member 22 and the biasing member 60. In this case the damping effect is provided by an elastomer 110a interfering with the coils 60a of a coil spring 60. The elastomer 110a may be bonded to the inner surface 27 of the retaining member 22. The coils 60a of the spring 60 acts as damping discs to increase the resistance to the movement of the retaining member 22 relative to the biasing member 60. As the mount 400 deflects under increased load, the gap between the coils 60a of the spring 60 decreases along with the length of the spring 60. Therefore, more coils 60a come into contact with the elastomer 110a. In this case, as the biasing member 60 is compressed the amount of interference between the retaining member 22 and the biasing member 60 in the region around the elastomer 110a increases, thus increasing the amount of frictional damping force. This type of damping may be termed “displacement dependent damping”, as the amount of damping is dependent upon the displacement of the biasing member 60 relative to the retaining member 22. In this embodiment the biasing member 60 is welded between the housing 10 and/or the retaining member 22 by welded washers 13, or riveted with rivets 15.

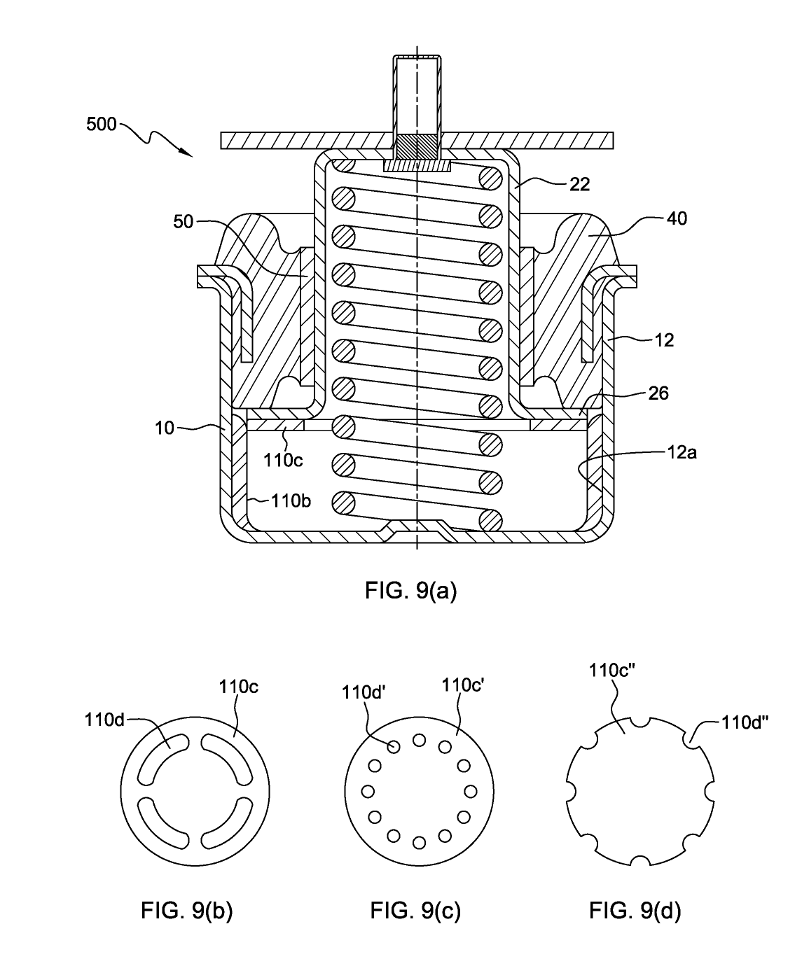

Furthermore, it should also be appreciated that additional, or alternative, surface effect damping could be achieved by including one or more friction discs or pads, or elastomer portions (an example of a friction interface) between the inner surface 12a of the cup portion 12 and the first damping plate 26, as illustrated in FIG. 9a.

FIG. 9a provides a vertical section view of an alternative embodiment of the mount, generally designated 500. The section is taken at the same point as that for FIG. 4(c) and illustrates optional features which could be added to the mount to add damping effects. The optional feature of FIG. 9a provides damping to the mount 500 in the form of surface effect damping. Unless otherwise indicated the features described are identical to those of the first embodiment and the same reference numerals have therefore been used.

The fifth embodiment of the mount 500 shown in FIG. 9a adds surface effect damping between the inner surface 12a of the cup portion 12 and the first damping plate 26. In this case the damping effect is provided by an elastomer 110b (an example of a friction interface) interfering with a damping disc 110c mounted to the first damping plate 26. The damping disc 110c may be attached to the first damping plate 26 by rivets, screws or any other suitable type of mechanical fastener, or could be welded. The damping disc 110c may be metal, plastic, e.g. rulon, or any other suitable type of material. The damping disc 110c interferes with the elastomer 110b to increase the resistance to the movement of the retaining member 22 relative to the cup portion 12.

Although not illustrated in FIG. 9a, it should be appreciated that the elastomer 110b may be tapered such that, as the biasing member 60 compresses, the amount of interference between the damping disc 110c and the elastomer 110b increases, thus increasing the amount of frictional damping force. As described above, this damping may be termed “displacement dependent damping” and is dependent upon the displacement of the biasing member 60 relative to the retaining member 22.

As illustrated in FIGS. 9b to 9d, the damping disc 110c, 110c′, 110c″ may take various forms. The damping disc 110c of FIGS. 9b to 9d all include liquid flow channels 110d, 110d′, 110d″ to allow the flow of liquid therethrough if viscous damping is used.

Also, although the viscous damping structure has been illustrated and described above as being located within the housing 10 of the mount 300, it should be appreciated that the viscous damping structure may be located externally to the mount. In this case the liquid would flow between two or more external chambers when the retaining member moves in either axial direction to provide the damping effect. Also, the viscous damping structure may alternatively be located at least partially externally to the mount. That is, a portion of the viscous damping structure (for example a first chamber) could be located outside the housing of the mount and another portion of the viscous damping structure (for example a second chamber) could be located within the housing of the mount. In this case the liquid would flow between the two chambers when the retaining member moves in either axial direction.

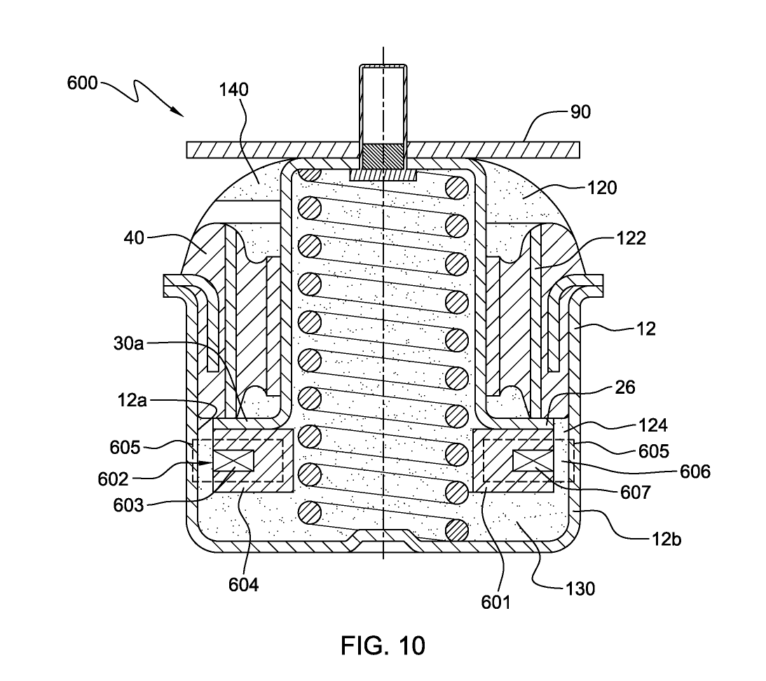

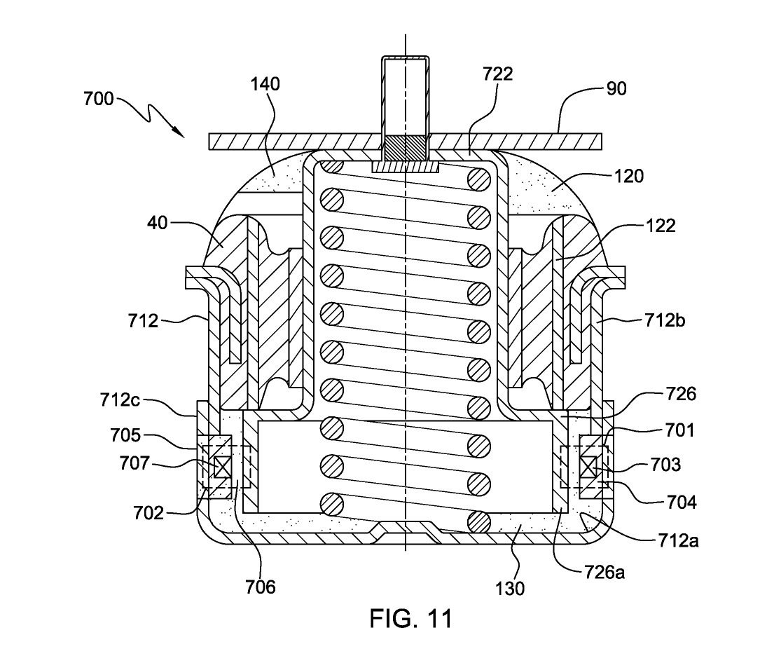

FIGS. 10 and 11 provide vertical section views of alternative embodiments of the mount 300 of FIG. 7. The sections are taken at the same point as that for FIG. 4(c). Unless otherwise indicated the features described are identical to those of the first embodiment and the same reference numerals have therefore been used.

The sixth embodiment of the mount 600 shown in FIG. 10 has been adapted to include a magnetorheological (MR) valve 601 arranged between the first damping plate 26 and the inner surface 12a of the cup portion 12. An electromagnet 602 is formed on the bottom surface 30a of the open end 30 of the retaining member 22. The electromagnet 602 includes a coil 603 and a flux core 604. The electromagnetic flux path 605 thus extends between the electromagnet flux core 604, a liquid gap 606 between the flux core 604 and the wall 12b of the cup portion 12. The electromagnet 602 also includes current carrying wires 607 to supply electrical current to the coil 603. The wires 607 may be connected to an external controller (not shown). The dimensions of the gap 606 may be adjustable by, for example, adjusting the size of the electromagnet 602, housing 10 or retaining member 22. The electromagnet 602, housing 10 or retaining member 22 may also have adjustable dimensions, such as an adjustable die, or crimped portion, or may include one or more stepped portions of differing dimensions.

The apparent viscosity of the liquid in the mount 600 is controlled in the same manner as described above in relation to the third embodiment of FIG. 7. In operation the valve 601 allows the liquid to flow between the gap 606 in a controlled manner upon displacement of the retaining member 22. The damping is created by the flow of liquid through the gap 606.

The seventh embodiment of the mount 700 shown in FIG. 11 is similar to the sixth embodiment of FIG. 10, except the electromagnet 702 is fixed to the cup potion 12. The magnetorheological (MR) valve 701 is again arranged between the first damping plate 726 and the inner surface 712a of the cup portion 712. The cup portion 712 includes an upper portion 712b and a lower portion 712c with the electromagnet 702 mounted to the lower portion 712c. However, it should be appreciated that the electromagnet 702 could alternatively be mounted to the upper portion 712b, such as proximate flow passages 122. The electromagnet 702 includes a coil 703 and a flux core 704. The electromagnetic flux path 705 extends between the electromagnetic flux core 704, a liquid gap 706 and an extended portion 726a of the first damping plate 726. The electromagnet 702 also includes current carrying wires 707 to supply electrical current to the coil 703. The wires 707 may be connected to a variable current source controller, preferably an external controller (not shown).

The apparent viscosity of the liquid in the mount 700 is controlled in the same manner as described above in relation to the third and sixth embodiments of FIGS. 7 and 10. In operation the valve 701 allows the liquid to flow between the gap 706 in a controlled manner upon displacement of the retaining member 722. The damping is created by the flow of liquid through the gap 706. An increased current supplied to the electromagnet increases the yield strength of the MR liquid.

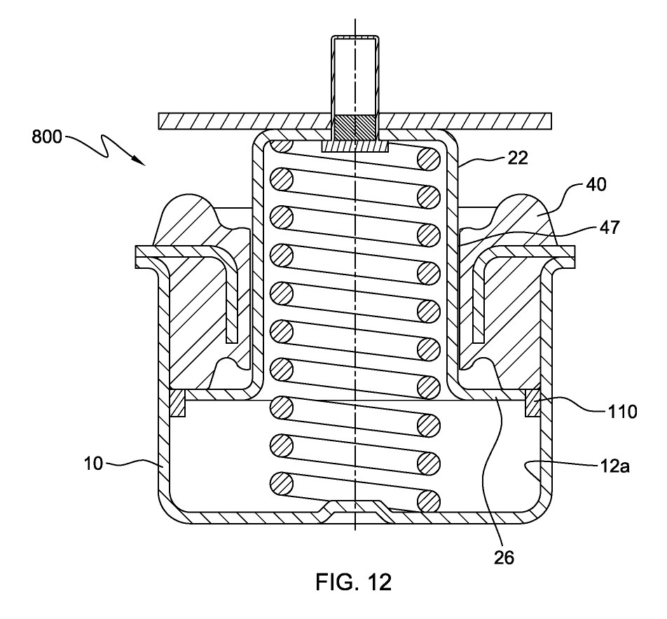

FIG. 12 provides a vertical section view of an alternative embodiment of the mount, generally designated 800. The section is taken at the same point as that for FIG. 4(c) and illustrates optional features which could be added to the mount to add damping effects. The optional feature of FIG. 12 provides damping to the mount in the form of surface effect damping. Unless otherwise indicated the features described are identical to those of the first embodiment and the same reference numerals have therefore been used.

The eighth embodiment of the mount 800 shown in FIG. 12 adds surface effect damping between the internal surface 47 of the seal, or cap, 40 and the retaining member 22. In this case the damping effect is provided by the elastomer material of the seal 40 rubbing against the retaining member 22 (an example of a friction interface).

Furthermore, it should also be appreciated that additional, or alternative, surface effect damping could be achieved by including one or more friction discs or pads, 110 or elastomer portions (an example of a friction interface) between the inner surface 12a of the cup portion 12 and the first damping plate 26, as illustrated in FIG. 12.

Furthermore, it should be appreciated that when surface effect damping is used it is possible to bring the retaining member 22 or the biasing member 60 into contact with one or more of the friction discs or pads, or elastomers before either the first damping plate 26 contacts the seal 40 or the second damping plate 90 contacts the seal 40. In this case this would create a system stiffness rate curve with four distinguishable regions: (1) biasing member 60, (2) biasing member 60+surface effect damping, (3) biasing member+viscous damping and biasing member 60+seal 40.

Also, although the sleeve 50 has been illustrated and described above as being formed from a plastics material, it should be appreciated that the sleeve could be a sliding bearing comprised of a dry metal polymer bearing, preferably with a metal backing, such as steel, and preferably with a bonded porous bronze sinter layer impregnated and overlaid with filled polytetrafluoroethylene (PTFE) based polymer bearing lining material. The sliding bearing may be a metal backed PTFE bearing. The sliding bearing may be formed separately from the seal 40 and may be mounted by slotting the bearing into the seal 40.

Furthermore, although in the third embodiment of the mount 300, illustrated in FIG. 7, the membrane liquid barrier 120 is placed over the closed end 28 of the retaining member 22 and attached around the circumference of the flange 48b of the seal ring 48 to provide a liquid seal to prevent the liquid escaping from the mount 300, it should be appreciated that the membrane liquid barrier may be located around the closed end 18 of the housing 10. In this case the closed end 18 would contain liquid flow channels, for example, holes, perforations etc., to allow the liquid to flow therethrough. The liquid flow channels in the housing would avoid the need to provide the flow passages 122 in the seal 40. The liquid membrane liquid barrier 120 would be placed over the closed end 18 of the housing 10 and attached around the circumference thereof to provide a liquid seal to prevent the liquid escaping from the mount. The operation of the mount is similar to the mount 300 and the viscous damping is provided in a similar manner.

Also, although in the embodiments described above the sleeve member 50 has been illustrated and described above as having an axial length which is shorter than the distance between the first and second control surfaces 44, 46, it should be appreciated that the sleeve member 50 may have an axial length which is greater than the distance between the first and second control surfaces 44, 46. In this case, during operation of the mount, either the first or second damping plate 26, 90 will come into contact with the upper or lower portion of the sleeve 50 before the first or second control surface 44, 46 of the seal 40. This adds additional stiffness to the system.

In preferred liquid-free mount embodiments, the mount is substantially free of fluids wherein mount damping is not provided by movement of a viscous damping liquid fluid. In such liquid-free mount embodiments the mount preferably does not contain a damping fluid or a seal for containing a damping fluid.

In such liquid-free mount embodiments damping is preferably provided with surface effect damping.

These and other modifications and improvements may be incorporated without departing from the scope of the invention.

1. A mount for mounting a second structure on a first structure, the mount comprising:
a housing having a first attachment surface for attachment to the first structure;
a biasing member having a first end located within the housing;
a cup-shaped retaining member having a second attachment surface for attaching the retaining member to the second structure, the retaining member being adapted to receive a second end of the biasing member and at least partially locate within the housing such that the biasing member is constrained by the retaining member and the housing; and
a cap surrounding the retaining member and providing a seal between the exterior of the retaining member and the interior of the housing;
wherein the cap includes a substantially rigid inner sleeve member adapted to prevent radial movement of the retaining member relative to the cap and housing.

2. The mount of claim 1, wherein the retaining member has a closed end having an interior surface and an exterior surface, wherein the interior surface constrains the second end of the biasing member and the exterior surface is the second attachment surface.

3. The mount of claim 1, wherein the cap includes a first control surface adapted to limit the relative axial movement of the retaining member in a first direction, and the retaining member includes a first radially projecting damping plate projecting towards the housing and adapted to selectively contact the first control surface of the cap.

4. The mount of claim 3, wherein the first control surface is adapted to limit the relative axial movement of the retaining member in a first direction away from the housing, and the cap includes a second control surface adapted to limit the relative axial movement of the retaining member in a second direction towards the housing.

5. The mount of claim 4, further comprising a threaded attachment member axially projecting from the second attachment surface, and a second damping plate located on the threaded attachment member and adapted to selectively contact the second control surface of the cap.

6. The mount of claim 3, further comprising one or more friction members adapted to generate friction between the retaining member and housing and/or between the retaining member and the biasing member.

7. The mount of claim 6, wherein the one or more friction members are located on the circumference of the first damping plate and/or on an internal surface of the cup-shaped retaining member and/or on an inner surface of the retaining member and are contactable with the coils of the spring.

8. The mount of claim 1, wherein the mount contains a fluid, and the cap further comprises:
a membrane adapted to seal the fluid within the housing; and
one or more orifices allowing the fluid to flow through the cap between a first fluid chamber formed between the cap and the membrane and a second fluid chamber formed between the cap and the housing.

9. The mount of claim 8, wherein the fluid is a magnetorheological fluid, and the mount further comprises an electromagnet located in the housing and adapted to selectively apply a magnetic field to the fluid.

10. The mount of claim 1, whereupon the mount is substantially liquid-free.

11. A mount for mounting a second structure on a first structure, the mount comprising:
a housing having a first attachment surface for attachment to the first structure;
a biasing member having a first end located within the housing;
a cup-shaped retaining member having a second attachment surface for attaching the retaining member to the second structure, the retaining member being adapted to receive a second end of the biasing member and at least partially locate within the housing such that the biasing member is constrained by the retaining member and the housing; and
a cap surrounding the retaining member and providing a seal between the exterior of the retaining member and the interior of the housing;
wherein the cap includes a friction interface adapted to control movement of the retaining member relative to the cap and housing.

12. A mount for mounting a second structure on a first structure, the mount comprising:
a housing having a first attachment surface for attachment to the first structure;
a biasing member having a first end located within the housing;
a magnetorheological fluid in the housing and in contact with the biasing member;
a fluid barrier, wherein the magnetorheological fluid is contained in said housing and the biasing member supports a load between the first and second structures.
